(19) United States
(12) Patent Application Publication
(10) Pub. No.: US 2026/0237581 A1
(43) Pub. Date: Aug. 13, 2026

(54) Contactor Static Contact, Static Contact Assembly and Contactor

(71) Applicants: Tyco Electronics (Shanghai) Co., Ltd., Shanghai (CN); Tyco Electronics Technology (SIP) Co., Ltd., Suzhou (CN)

(72) Inventors: Zesheng Jiang, Suzhou (CN); Quarry (Bingfeng) Qu, Suzhou (CN); Kevin (Xujia) Wang, Suzhou (CN); Lizhong Wang, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/534,901

(22) Filed: Feb. 10, 2026

(30) Foreign Application Priority Data
Feb. 10, 2025 (CN) 202520204986.8

(51) Int. Cl. H01H 50/14; H01H 50/22

(52) U.S. Cl. CPC H01H 50/14; H01H 50/22

(57) ABSTRACT

A contactor static contact includes a static terminal and a static contact point. The static terminal has a main body and a heat dissipation plate connected to one side of the main body. The main body is used for electrical connection to a load circuit to carry a load current. The static contact point is set on the main body for electrical contact with a movable contact point of a movable contact of a contactor. the static terminal is an integral piece. A heat of the contactor static contact can be transferred to an outer housing of the contactor through the heat dissipation plate and dissipated to an outside through the outer housing.

### CROSS-REFERENCE TO RELATED APPLICATION

This application claims the benefit of the filing date under 35 U.S.C. § 119(a)-(d) of Chinese Patent Application No. CN202520204986.8 filed on Feb. 10, 2025, the whole disclosure of which is incorporated herein by reference.

### FIELD OF THE INVENTION

The present invention relates to a contactor static contact and, more particularly, to a contactor static contact, a static contact assembly comprising the contactor static contact, and a contactor comprising the static contact assembly.

### BACKGROUND OF THE INVENTION

A non-inflatable contactor typically includes an upper outer housing, a lower outer housing, a static contact, a movable contact, and an electromagnetic drive module. The upper outer housing limits the arc extinguishing chamber, and the static terminal is fixed to the upper outer housing. The movable contact is set in the arc extinguishing chamber of the upper outer housing. The electromagnetic drive module is installed in the lower outer housing and is used to drive the movable contact to move between the closed position in electrical contact with the static contact and the open position in electrical separation from the static contact. The upper and lower outer housings are assembled together through buckles. However, there is no seal between the upper and lower outer housings, and external pollutants (such as gases containing Si and S) can enter the arc extinguishing chamber, which can contaminate the contact points of the movable and static contacts and affect their contact resistance. In addition, the static terminal of the static contact is usually cylindrical without a heat dissipation structure, which can cause the internal temperature of the contactor to be too high, affecting the current carrying performance. In addition, when a short circuit occurs in the load circuit, the short-circuit current will generate electrical repulsion between the movable and static contacts. Excessive short-circuit current can cause the movable and static contacts to be accidentally disconnected. With the increasing demand for short-circuit current in the market, it is necessary to improve the product's short-circuit resistance performance.

### SUMMARY OF THE INVENTION

A contactor static contact includes a static terminal and a static contact point. The static terminal has a main body and a heat dissipation plate connected to one side of the main body. The main body is used for electrical connection to a load circuit to carry a load current. The static contact point is set on the main body for electrical contact with a movable contact point of a movable contact of a contactor. the static terminal is an integral piece. A heat of the contactor static contact can be transferred to an outer housing of the contactor through the heat dissipation plate and dissipated to an outside through the outer housing.

### BRIEF DESCRIPTION OF DRAWINGS

The invention will now be described by way of example with reference to the accompanying figures, of which:

FIG. 1 is a perspective view of a contactor according to an exemplary embodiment;

FIG. 2 is an exploded view of the contactor of FIG. 1;

FIG. 3 is a perspective view of the contactor of FIG. 1, where a sealing glue has not yet been poured into a top opening of an outer housing;

FIG. 4 is a perspective view of a static contact module and a movable contact module of the contactor of FIG. 1;

FIG. 5 is a perspective view of the outer housing of FIG. 3 of the contactor of FIG. 1 and a stopper plate of the contactor of FIG. 1;

FIG. 6 is a perspective view of the static contact module of FIG. 4;

FIG. 7 is an exploded view of the static contact module of FIG. 4;

FIG. 8 is a perspective view of a static contact assembly of the contactor of FIG. 1;

FIG. 9 is a cross-sectional view of the static contact assembly of FIG. 8;

FIG. 10 is an exploded top view of the static contact assembly of FIG. 8;

FIG. 11 is an exploded bottom view of the static contact assembly of FIG. 8;

FIG. 12 is a perspective view of a contactor according to another exemplary embodiment; and

FIG. 13 is an exploded view of a contactor according to another exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

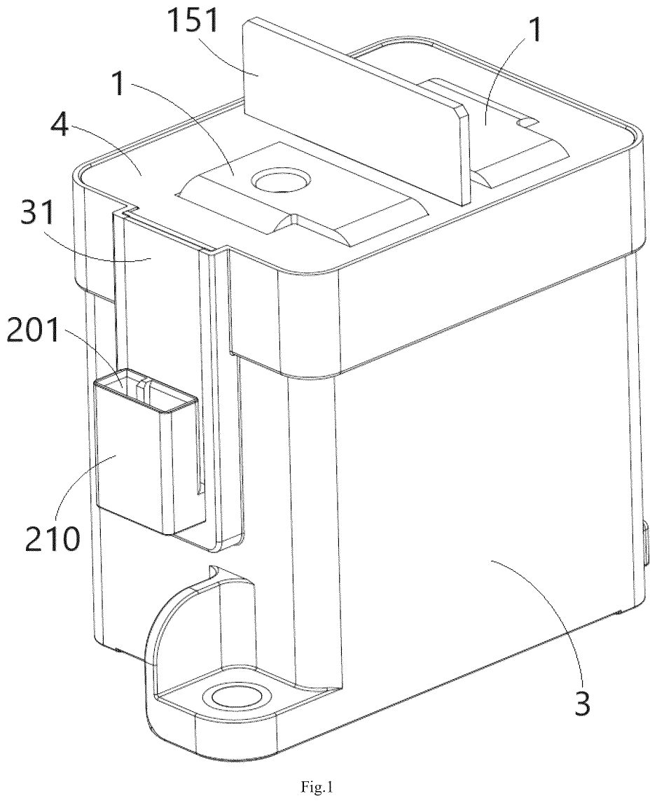

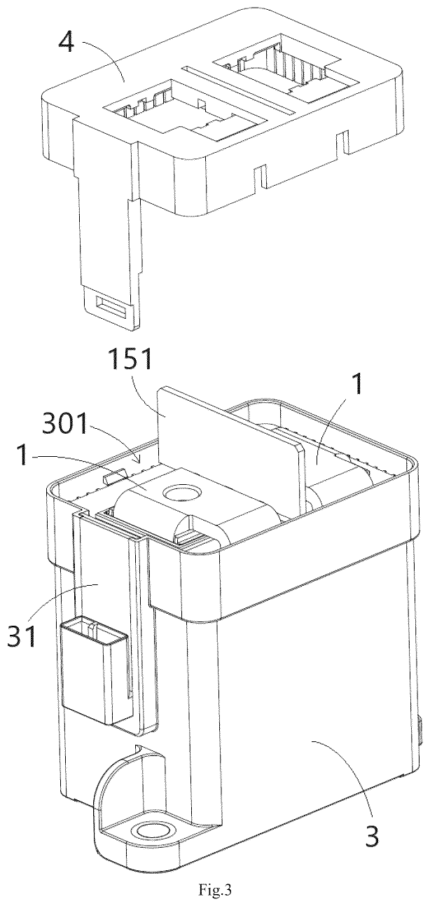

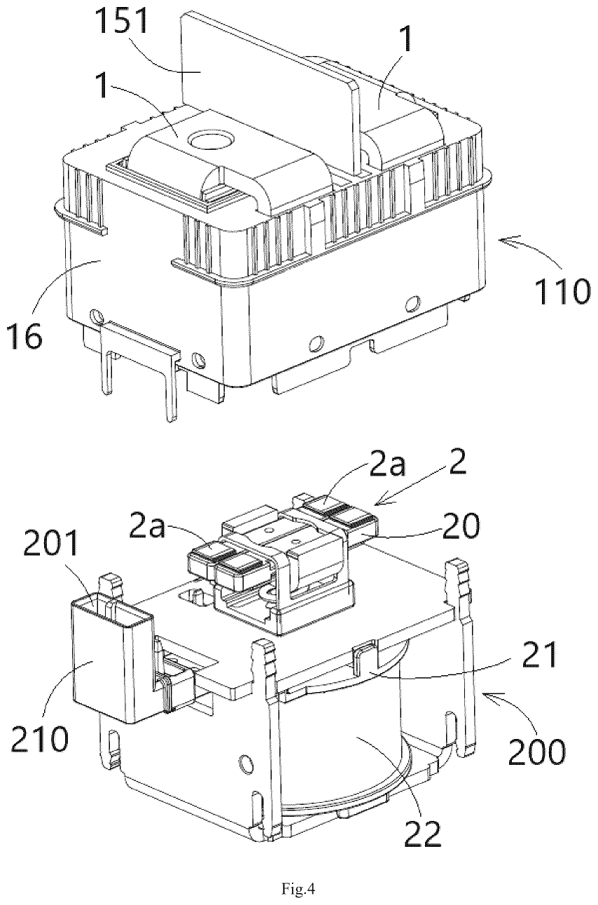

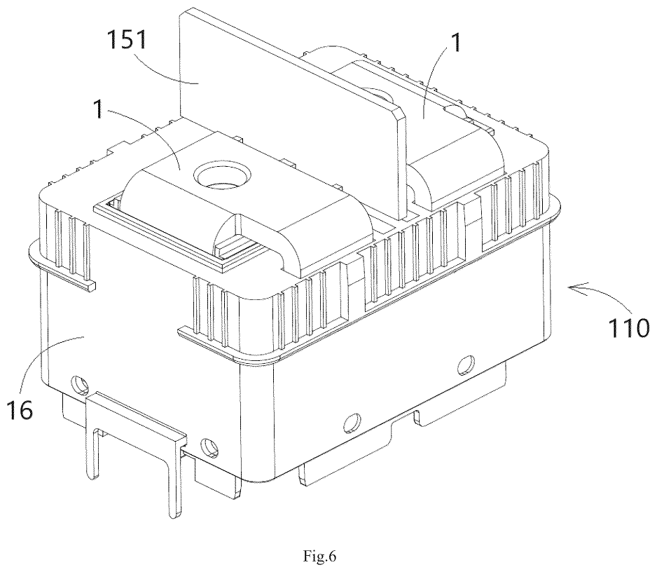

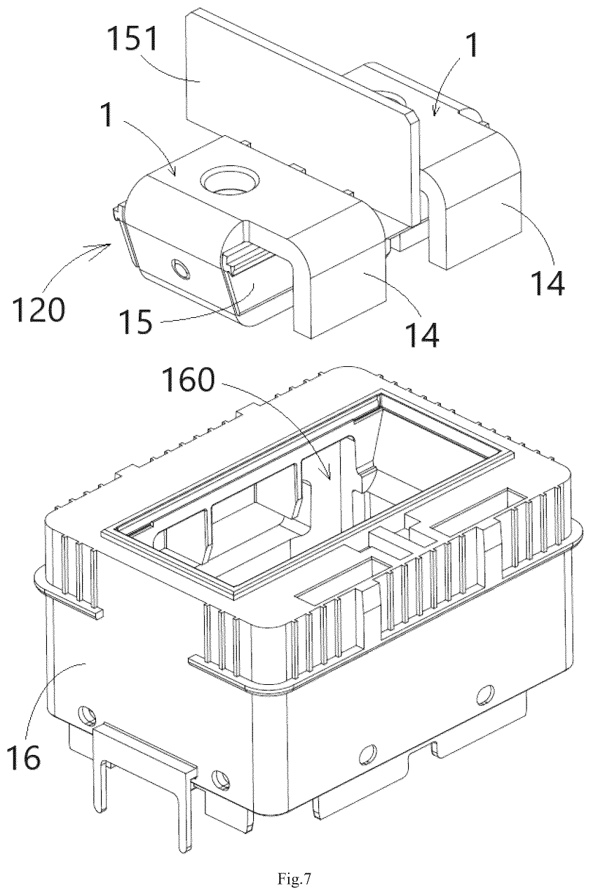

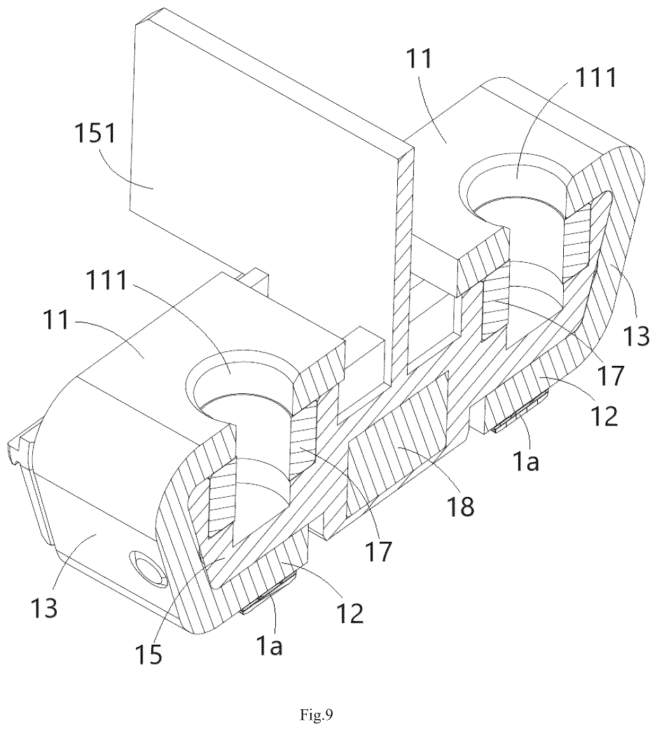

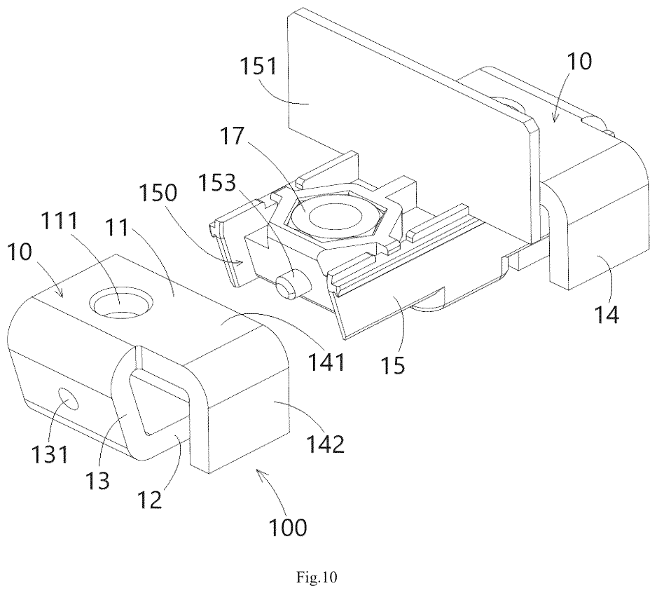

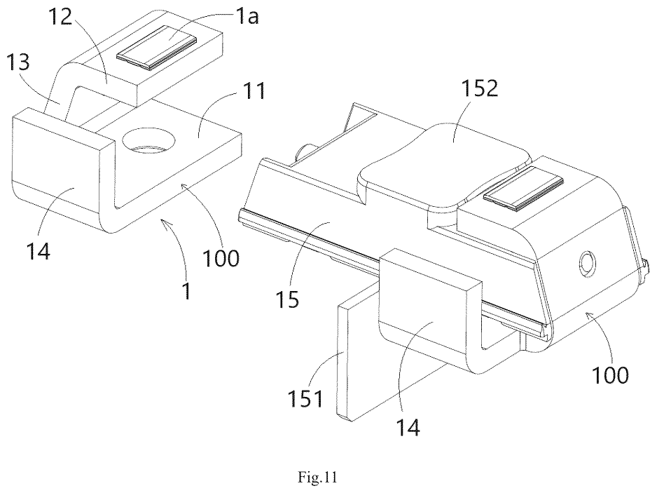

An exemplary embodiment of a contactor static contact 1 will now be described with reference to FIGS. 1-11. The contactor static contact 1 includes a static terminal 100, as shown in FIGS. 10-11, and a static contact point 1a, as shown in FIGS. 9 and 11. As shown in FIGS. 7-9 and 10-11, the static terminal 100 includes a main body 10 and a heat dissipation plate 14. The main body 10 is used for electrical connection to a load circuit to carry load current. The heat dissipation plate 14 is connected to one side of the main body 10. The static contact point 1a is set on the main body 10 for electrical contact with a movable contact point 2a, as shown in FIG. 4, of a movable contact 2 of a contactor. The static terminal 100 is an integrated component. For example, the static terminal 100 can be an integral stamped part or an integral machined part. The heat of the contactor static contact 1 can be transferred to an outer housing 3, as shown in FIGS. 1-3 and 5, of the contactor through the heat dissipation plate 14 and dissipated to the outside through the outer housing 3, thereby improving the heat dissipation performance of the contactor.

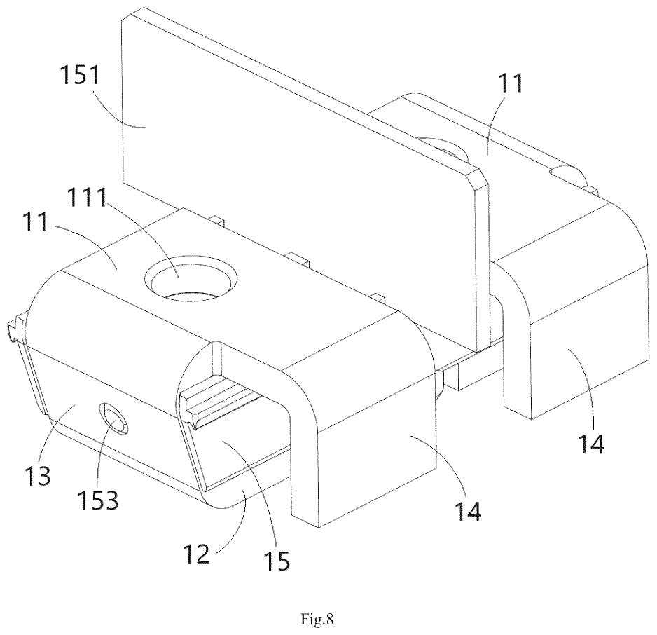

As shown in FIGS. 8-11, the main body 10 of the static terminal 100 includes a top plate 11, a bottom plate 12, and a side plate 13 located between one sides of the top plate 11 and the bottom plate 12, so that the main body 10 of the static terminal 100 is U-shaped and suitable for fitting onto an insulation seat 15, as shown in FIGS. 7-11, of the contactor. The static contact point 1a is fixed to the bottom surface of the bottom plate 12 of the static terminal 100, and the top plate 11 of the static terminal 100 is used for electrical connection to the load circuit.

As shown in FIGS. 8-10, a connection hole 111 is formed in the top plate 11 of the static terminal 100 to allow a bolt to pass through, so that the top plate 11 of the static terminal 100 can be fastened to the load circuit through the bolt. The top plate 11 and bottom plate 12 of the static terminal 100 are perpendicular to the axial direction of the connection hole 111. The side plate 13 extends downward at an angle relative to the top plate 11.

The side plate 13 of the static terminal 100 is adapted to be embedded into a positioning slot 150, as shown in FIG. 10, on the insulation seat 15. As shown in FIG. 10, a positioning hole 131 is formed in the side plate 13 of the static terminal 100 for engaging with a positioning post 153 on the insulation seat 15.

As shown in FIG. 10, the heat dissipation plate 14 includes a first heat dissipation plate 141 and a second heat dissipation plate 142. One end of the first heat dissipation plate 141 is connected to the side of the top plate 11, bottom plate 12, or side plate 13 of the main body 10. The second heat dissipation plate 142 is vertically connected to the other end of the first heat dissipation plate 141. The second heat dissipation plate 142 is adjacent to the outer housing 3 of the contactor or used for thermal contact with the outer housing 3 of the contactor, so that the heat of the contactor static contact 1 can be transferred to the outer housing 3 of the contactor through the second heat dissipation plate 142.

An exemplary embodiment of a static contact assembly 120 will now be described with reference to FIGS. 1-11. The static contact assembly 120 includes the insulation seat 15 and two contactor static contacts 1. The two contactor static contacts 1 are assembled onto the insulation seat 15. The heat dissipation plate 14 of the static terminal 100 is suspended on one side of the insulation seat 15. The top plate 11 and bottom plate 12 of the static terminal 100 are respectively located on the top and bottom surfaces of the insulation seat 15. The positioning slot 150, as shown in FIG. 10, is formed on the side between the top and bottom surfaces of the insulation seat 15, and the side plate 13 of the static terminal 100 is embedded in the positioning slot 150 of the insulation seat 15.

As shown in FIG. 10, the positioning post 153 is formed on the side of the insulation seat 15. The positioning post 153 is engaged with the positioning hole 131 on the side plate 13 of the static terminal 100.

As shown in FIGS. 1, 3-4, and 6-10, a vertically extending insulation partition 151 is formed on the top surface of the insulation seat 15. The insulation partition 151 is used to separate the top plates 11 of the two static terminals 100 from each other, in order to increase the creepage distance between the top plates 11 of the two static terminals 100. An insulation rib 152, as shown in FIG. 11, is formed on the bottom surface of the insulation seat 15, which is used to separate the bottom plates 12 of the two static terminals 100 from each other, in order to increase the creepage distance between the bottom plates 12 of the two static terminals 100.

As shown in FIGS. 9-10, the static contact assembly 120 further includes two nuts 17. The two nuts 17 are fixed in the insulation seat 15 and correspond to the connection holes 111 in the top plate 11 of the two static terminals 100. The nut 17 is used to connect with the bolt passing through the connection hole 111 to electrically connect the static terminal 100 to a load circuit.

As shown in FIG. 9, the static contact assembly 120 further includes an electromagnetic soft iron 18, which is fixed in the insulation seat 15. The electromagnetic soft iron 18 is located between two static terminals 100, used to adsorb a movable terminal assembly 20 of the contactor to resist the electrical repulsion generated between the contactor static contact 1 and the movable contact 2 of the contactor. The electromagnetic soft iron 18 is a magnetic conductor that can be magnetized by the current flowing through the contacts of the contactor. Therefore, the present invention can improve the short-circuit current resistance of the contactor. The nut 17 or the electromagnetic soft iron 18 can be assembled into the insulation seat 15. However, the present invention is not limited to this, and the insulation seat 15 can also be directly injection molded onto the nut 17 or the electromagnetic soft iron 18.

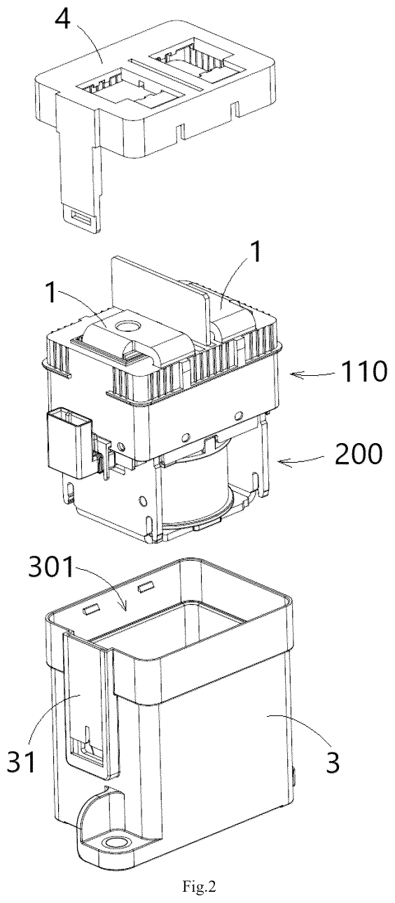

An exemplary embodiment of a contactor will now be described with reference to FIGS. 1-11. The contactor includes the outer housing 3, as shown in FIGS. 1-3 and 5, a movable contact module 200, as shown in FIGS. 2 and 4, and a static contact module 110, as shown in FIGS. 2 and 4. The outer housing 3 includes a peripheral wall, a bottom wall, and a top opening 301, as shown in FIGS. 2-3 and 5, opposite the bottom wall. The movable contact module 200 is installed into the outer housing 3 through the top opening 301. As shown in FIG. 4, the movable contact module 200 includes a movable contact 2. The static contact module 110 is installed into the outer housing 3 through the top opening 301 and located above the movable contact module 200. The static contact module 110 includes an inner housing 16, as shown in FIGS. 4 and 6-7, and a static contact assembly 120, as shown in FIG. 7. The static contact assembly 120 is assembled into the inner housing 16, and sealing glue 4, as shown in FIGS. 1-3, is poured into the top opening 301 of the outer housing 3 to seal the top opening 301 of the outer housing 3, effectively preventing external pollutants from entering the outer housing 3, so that the contact points of the movable contact 2 and the contactor static contacts 1 of the contactor are not contaminated by external pollutants. The top surface of the static terminal 100 is exposed from the sealing glue 4 for electrical connection to the load circuit.

The heat dissipation plate 14 of the static terminal 100 is adjacent to or in thermal contact with the inner surface of the outer housing 3, so that the heat of the contactor static contact 1 can be transferred to the outer housing 3 through the heat dissipation plate 14 and dissipated to the outside of the contactor through the outer housing 3.

As shown in FIG. 7, an arc extinguishing chamber 160 is defined inside the inner housing 16. The static contact point 1a of the contactor static contact 1 and the movable contact 2 of the contactor are located in the arc extinguishing chamber 160. The movable contact module 200 also includes an electromagnetic drive module for driving the movable contact 2 to move between a closed position in electrical contact with the static contact point 1a and an open position in electrical separation from the static contact point 1a.

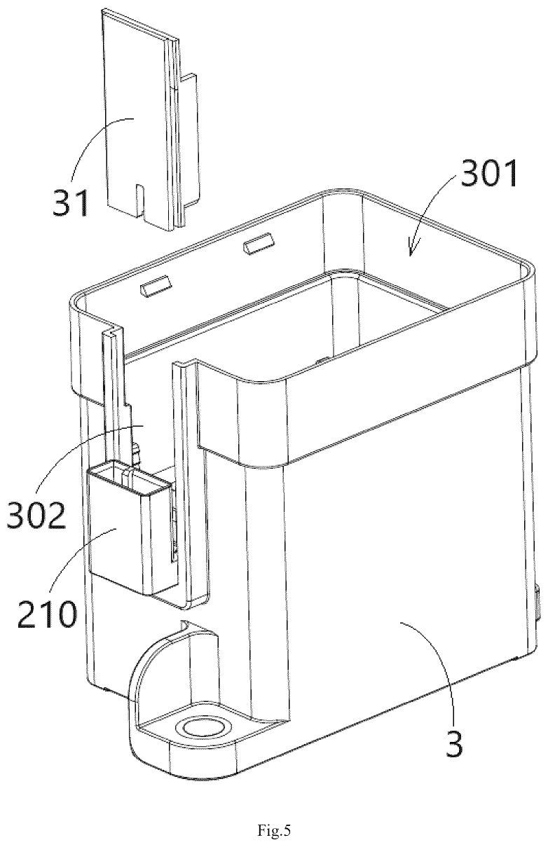

As shown in FIG. 4, the electromagnetic drive module comprises a coil assembly, which includes a coil skeleton 21 and a coil 22 wound around the coil skeleton 21. A mating part 210 with an insertion cavity 201 is formed on the coil skeleton 21, and the coil 22 has coil terminals extending into the insertion cavity 201. The mating part 210 and the coil terminals form a connector interface for mating with a connector. A slot hole 302, as shown in FIG. 5, extending downward from its upper end face is formed on the peripheral wall of the outer housing 3, and the mating part 210 extends from the outer housing 3 through the slot hole 302. The contactor also includes a stopper plate 31, as shown in FIGS. 1-3 and 5, inserted into the slot hole 302 of the outer housing 3 to prevent the sealing glue 4 poured into the top opening 301 of the outer housing 3 from flowing out of the outer housing 3.

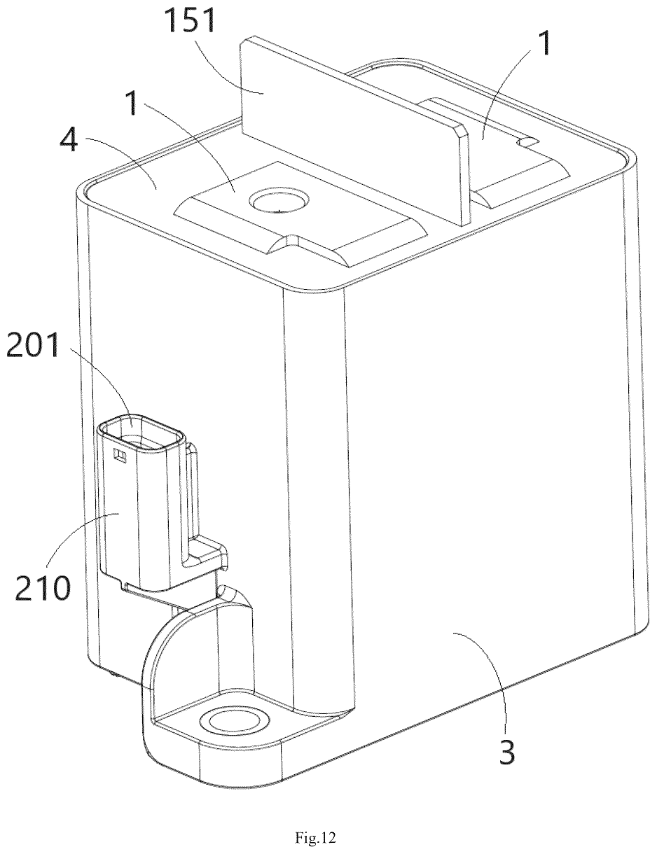

FIG. 12 shows an illustrative perspective view of a contactor according to another exemplary embodiment of the present invention.

Another exemplary embodiment of a contactor will now be described with reference to FIG. 12. The main difference between the contactor according to FIG. 12 and the contactor according to FIGS. 1-11 is the structure of the outer housing 3 and the coil skeleton 21. In addition, other technical features of the contactor according to FIG. 12 are basically the same as those of the contactors according to FIGS. 1-11, which can be referred to as the contactors shown in FIGS. 1-11. The electromagnetic drive module comprises a coil assembly, which includes a coil skeleton 21 and a coil 22 wound around the coil skeleton 21. A mating part 210 with an insertion cavity 201 is formed on the outer side of the peripheral wall of the outer housing 3, and the coil 22 has coil terminals extending into the insertion cavity 201. The mating part 210 and the coil terminals form a connector interface for mating with a connector. In the embodiment shown in FIG. 12, the aforementioned stopper plate 31 is omitted, simplifying the structure of the contactor and reducing manufacturing costs.

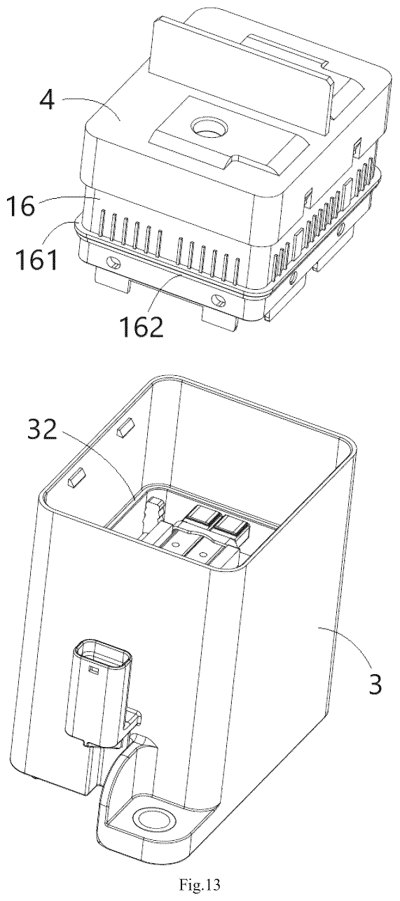

Another exemplary embodiment of a contactor will now be described with reference to FIG. 13. As shown in FIG. 13, a ring of outer flange 161 is formed on the outer side of the inner housing 16, and a ring of inner flange 32 is formed on the inner side of the outer housing 3. The contactor also includes a sealing ring 162, which is fitted onto the inner housing 16 and compressed between the outer flange 161 and the inner flange 32 to achieve sealing between the inner housing 16 and the outer housing 3.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A contactor static contact, comprising:
a static terminal having a main body and a heat dissipation plate connected to one side of the main body, the main body is used for electrical connection to a load circuit to carry a load current; and
a static contact point set on the main body for electrical contact with a movable contact point of a movable contact of a contactor, the static terminal is an integral piece, and a heat of the contactor static contact can be transferred to an outer housing of the contactor through the heat dissipation plate and dissipated to an outside through the outer housing.

2. The contactor static contact of claim 1, wherein the main body of the static terminal has a top plate, a bottom plate, and a side plate between one side of the top plate and one side of the bottom plate, such that the main body of the static terminal is U-shaped and fits onto an insulation seat of the contactor, the static contact point is fixed to a bottom surface of the bottom plate of the static terminal, and the top plate of the static terminal is used for electrical connection to the load circuit.

3. The contactor static contact of claim 2, wherein a connection hole is formed in the top plate of the static terminal, the connection hole allows a bolt to pass through, such that the top plate of the static terminal can be fastened to the load circuit through the bolt.

4. The contactor static contact of claim 3, wherein the top plate and the bottom plate of the static terminal are perpendicular to an axial direction of the connection hole, the side plate extends downward at an angle relative to the top plate.

5. The contactor static contact of claim 2, wherein the side plate of the static terminal is embedded into a positioning slot on the insulation seat, and a positioning hole is formed in the side plate of the static terminal for engaging with a positioning post on the insulation seat.

6. The contactor static contact of claim 2, wherein the heat dissipation plate includes a first heat dissipation plate and a second heat dissipation plate, the first heat dissipation plate has one end connected to a side of the top plate, the bottom plate, or the side plate of the main body, the second heat dissipation plate is vertically connected to an other end of the first heat dissipation plate, the second heat dissipation plate is adjacent to the outer housing of the contactor or used for thermal contact with the outer housing of the contactor, such that the heat of the contactor static contact of the contactor can be transferred to the outer housing of the contactor through the second heat dissipation plate.

7. The contactor static contact of claim 1, wherein the static terminal is an integral stamped or machined part.

8. A static contact assembly, comprising:
an insulation seat; and
two contactor static contacts assembled onto the insulation seat, each contactor static contact includes a static terminal and a static contact point, the static terminal has a main body and a heat dissipation plate connected to one side of the main body, the main body is used for electrical connection to a load circuit to carry a load current, the static contact point is set on the main body for electrical contact with a movable contact point of a movable contact of a contactor, the static terminal is an integral piece, and a heat of the contactor static contact can be transferred to an outer housing of the contactor through the heat dissipation plate and dissipated to an outside through the outer housing, the heat dissipation plate of each static terminal is suspended on one side of the insulation seat.

9. The static contact assembly of claim 8, wherein a top plate and a bottom plate of each static terminal is respectively located on a top surface and a bottom surface of the insulation seat, a positioning slot is formed on a side between the top surface and the bottom surface of the insulation seat, a side plate of each static terminal is embedded in one positioning slot of the insulation seat.

10. The static contact assembly of claim 9, wherein a positioning post is formed on each side of the insulation seat, each positioning post is engaged with one positioning hole in the side plate of the static terminal.

11. The static contact assembly of claim 9, wherein a vertically extending insulation partition is formed on the top surface of the insulation seat, the insulation partition isolates the top plate of each static terminal from each other to increase a creepage distance between the top plate of each static terminal, an insulation rib is formed on the bottom surface of the insulation seat, the insulation rib isolates the bottom plate of each static terminal from each other to increase a creepage distance between the bottom plate of each static terminal.

12. The static contact assembly of claim 9, further comprising two nuts each fixed in the insulation seat and corresponding to a connection hole in the top plate of each static terminal, each nut connects with a bolt passing through one connection hole to electrically connect the respective static terminal to the load circuit.

13. The static contact assembly of claim 12, further comprising an electromagnetic soft iron fixed in the insulation seat, the electromagnetic soft iron is located between the two static terminals and adsorbs a movable terminal assembly of the contactor to resist an electrical repulsion generated between at least one static contact and the movable contact.

14. The static contact assembly of claim 13, wherein the nut or the electromagnetic soft iron is assembled into the insulation seat, or wherein the insulation seat is directly injection molded onto the nut or the electromagnetic soft iron.

15. A contactor, comprising:
an outer housing including a peripheral wall, a bottom wall, and a top opening opposite the bottom wall;
a movable contact module installed into the outer housing and having a movable contact; and
a static contact module installed in the outer housing and located above the movable contact module, the static contact module includes an inner housing and a static contact assembly assembled into the inner housing, the static contact assembly includes an insulation seat and two contactor static contacts assembled onto the insulation seat, each contactor static contact includes a static terminal and a static contact point, the static terminal has a main body and a heat dissipation plate connected to one side of the main body, the main body is used for electrical connection to a load circuit to carry a load current, the static contact point is set on the main body for electrical contact with a movable contact point of the movable contact, the static terminal is an integral piece, the heat dissipation plate of each static terminal is suspended on one side of the insulation seat, sealing glue is poured into the top opening of the outer housing to seal the top opening of the outer housing, and a top surface of the static terminal is exposed from the sealing glue for electrical connection to the load circuit.

16. The contactor of claim 15, wherein the heat dissipation plate of each static terminal is adjacent to or in thermal contact with an inner surface of the outer housing, such that a heat of each contactor static contact can be transferred to the outer housing through its heat dissipation plate and dissipated to the outside of the contactor through the outer housing.

17. The contactor of claim 15, wherein an arc extinguishing chamber is defined inside the inner housing, the static contact point of each contactor static contact and the movable contact are located in the arc extinguishing chamber, the movable contact module includes an electromagnetic drive module driving the movable contact to move between a closed position in electrical contact with the static contact point and an open position in electrical separation from the static contact point.

18. The contactor of claim 17, wherein the electromagnetic drive module has a coil assembly, the coil assembly includes a coil skeleton and a coil wound on the coil skeleton, a mating part with an insertion cavity is formed on the coil skeleton, and the coil has coil terminals extending into the insertion cavity, the mating part and the coil terminals form a connector interface for mating with a connector, a slot hole extending downward from its upper end face is formed on the peripheral wall of the outer housing, the mating part extends from the outer housing through the slot hole, the contactor also includes a stopper plate inserted into the slot hole of the outer housing to prevent the sealing glue poured into the top opening of the outer housing from flowing out of the outer housing.

19. The contactor of claim 17, wherein the electromagnetic drive module has a coil assembly, the coil assembly includes a coil skeleton and a coil wound around the coil skeleton, a mating part with an insertion cavity is formed on the outer side of the peripheral wall of the outer housing, the coil has coil terminals extending into the insertion cavity, the mating part and the coil terminals form a connector interface for mating with a connector.

20. The contactor of claim 19, wherein a ring of an outer flange is formed on an outer side of the inner housing, a ring of an inner flange is formed on an inner side of the outer housing, and the contactor further comprises a sealing ring fitted onto the inner housing and compressed between the outer flange and the inner flange to achieve sealing between the inner housing and the outer housing.
